(19) United States
(12) Patent Application Publication
(10) Pub. No.: US 2013/0009565 A1
(43) Pub. Date: Jan. 10, 2013

(54) ELECTRONIC BALLAST FOR PARALLEL LAMP OPERATION WITH PROGRAM START

(75) Inventor: Yuhong Fang, Naperville, IL (US)

(73) Assignee: KONINKLIJKE PHILIPS ELECTRONICS N.V., EINDHOVEN (NL)

(21) Appl. No.: 13/635,694

(22) PCT Filed: Feb. 23, 2011
(86) PCT No.: PCT/IB11/50752

§ 371 Date: Sep. 18, 2012

Related U.S. Application Data
(60) Provisional application No. 61/315,656, filed on Mar. 19, 2010.

(51) Int. Cl. H05B 41/295

(52) U.S. Cl. 315/254

(57) ABSTRACT

An electronic ballast for parallel lamp operation with program start including an electronic ballast for fluorescent lamps operably connected in parallel, each of the fluorescent lamps having lamp filaments. The electronic ballast includes a current fed self oscillating inverter (110) and preheat windings (127) operably connected to the current fed self oscillating inverter (110) to provide filament power (134) to the lamp filaments during the preheat time. The current fed self oscillating inverter (110) includes an output transformer (112) having a primary output transformer winding (114) and a secondary output transformer winding (116), the secondary output transformer winding (116) being operably connected to provide lamp power (132) to the fluorescent lamps; and a switch circuit (118) operably connected in series with the primary output transformer winding (114), the switch circuit (118) having a switch (120) operably connected in parallel with an inductor (124).

The technical field of this disclosure is power supplies, particularly, an electronic ballast for parallel lamp operation with program start.

Electronic ballasts can be used to provide high frequency AC power to light fluorescent lamps. Electronic ballasts commonly perform a number of power-related functions including, inter alia, the conversion of power from the primary sources to AC voltages and frequencies corresponding to the requirements of respective lamps, and the limiting and control of the flow of electrical current to the lamps.

Electronic ballasts can be divided into two major categories: program-start ballasts and instant-start ballasts. Program-start ballasts preheat lamp filaments before ignition and typically employ a controller driven topology. Instant-start ballasts provide a constant high voltage, so the lamps ignite as soon as power is on. Instant-start ballasts typically employ a self-oscillation topology. Each category of electronic ballast has its own advantages and disadvantages. Program-start ballasts provide a softer start, extending lamp life, but are expensive and difficult to use for independent lamp operation in multiple lamp installations because the lamps are wired in series. Instant-start ballasts are less expensive and are easy to use for independent lamp operation in multiple lamp installations because the lamps are wired in parallel, but provide a harder start because the full voltage is applied across the lamp without preheating the lamp filaments.

Unfortunately, present instant-start ballasts cannot provide the soft start of a program-start ballast. The instant-start ballast typically includes an electromagnetic interference (EMI) filter receiving AC mains voltage, a full wave bridge rectifier, a power factor correction (PFC), and a current-fed self oscillating half bridge inverter connected to the lamps. When power is turned on, the inverter starts operating and generates a constant high voltage to ignite lamp without preheating the lamp filaments. Attempts to provide the combination of program start and parallel lamp operation have resulted in complex circuits which are costly.

It would be desirable to have an electronic ballast for parallel lamp operation with program start that would overcome the above disadvantages.

One aspect of the present invention provides an electronic ballast for fluorescent lamps operably connected in parallel, each of the fluorescent lamps having lamp filaments, the electronic ballast including a current fed self oscillating inverter and preheat windings operably connected to the current fed self oscillating inverter to provide filament power to the lamp filaments during the preheat time. The current fed self oscillating inverter includes an output transformer having a primary output transformer winding and a secondary output transformer winding, the secondary output transformer winding being operably connected to provide lamp power to the fluorescent lamps; and a switch circuit operably connected in series with the primary output transformer winding, the switch circuit having a switch operably connected in parallel with an inductor, the switch being responsive to a preheat time signal to open the switch during a preheat time and close the switch after the preheat time.

Another aspect of the present invention provides a method of lamp operation with program start for fluorescent lamps operably connected in parallel, the method including operably connecting a current fed self oscillating inverter to the fluorescent lamps. The current fed self oscillating inverter includes an output transformer having a primary output transformer winding and a secondary output transformer winding, the secondary output transformer winding being operably connected to provide lamp power to the fluorescent lamps; and a switch circuit operably connected in series with the primary output transformer winding, the switch circuit having a switch operably connected in parallel with an inductor. The method further includes opening the switch during a preheat time, and closing the switch after the preheat time.

Yet another aspect of the present invention provides an electronic ballast for fluorescent lamps operably connected in parallel, each of the fluorescent lamps having a high end lamp filament and a low end lamp filament, the electronic ballast including a current fed self oscillating inverter; a filament control circuit operably connected in parallel with the secondary output transformer filament winding; high end preheat windings operably connected to the primary filament transformer winding, each of the high end preheat windings being operably connected to one of the high end lamp filaments; and a low end preheat winding operably connected to the primary filament transformer winding, the low end preheat winding being operably connected in parallel across the low end lamp filaments. The current fed self oscillating inverter includes an output transformer having a primary output transformer winding and a secondary output transformer winding operably connected in series with a secondary output transformer filament winding, the secondary output transformer winding being operably connected to provide lamp power to the fluorescent lamps; and a switch circuit operably connected in series with the primary output transformer winding, the switch circuit having a switch operably connected in parallel with an independent inductor, the switch including a first capacitor and first MOSFET in series, a source of the first MOSFET being operably connected to Ground, the switch being responsive to a preheat time signal to open the switch during a preheat time and close the switch after the preheat time; and a second capacitor operably connected between the primary output transformer winding and the switch circuit. The filament control circuit includes a third capacitor, a primary filament transformer winding, and a second MOSFET operably connected in series, the second MOSFET being responsive to a filament control signal to turn ON the second MOSFET during the preheat time and to turn OFF the second MOSFET after the preheat time.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

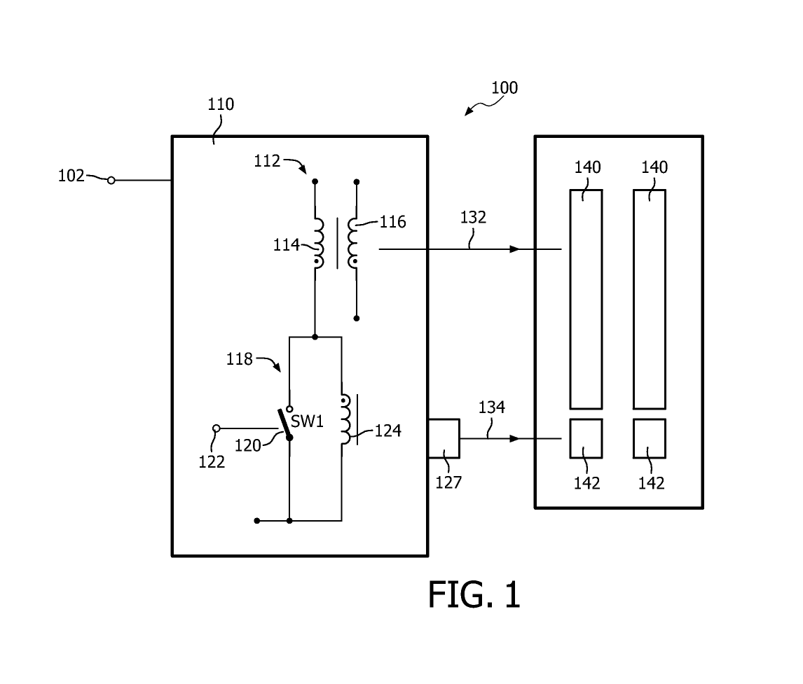

FIG. 1 is a block diagram of an electronic ballast in accordance with the present invention.

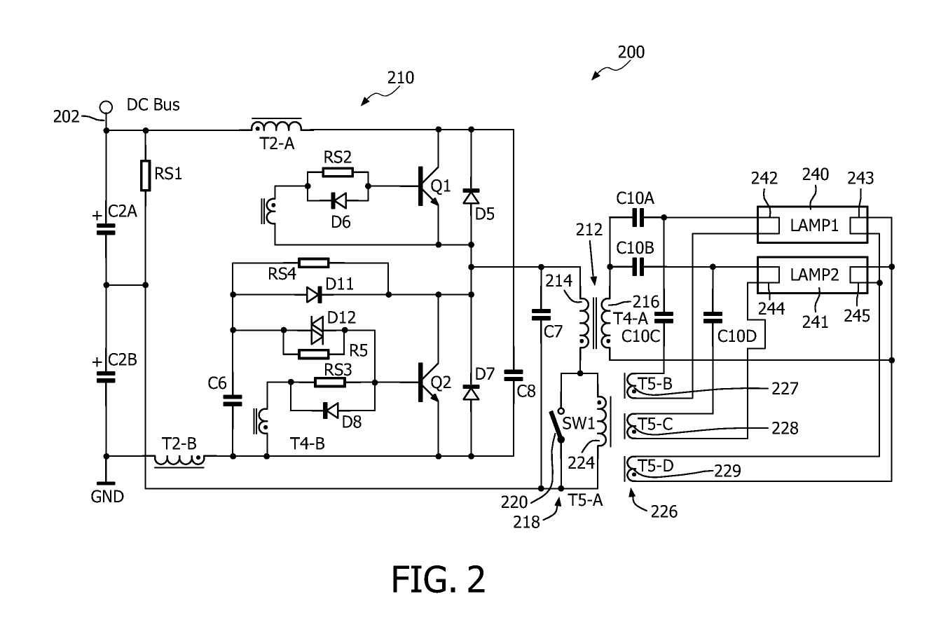

FIG. 2 is a schematic diagram of an embodiment of an electronic ballast in accordance with the present invention.

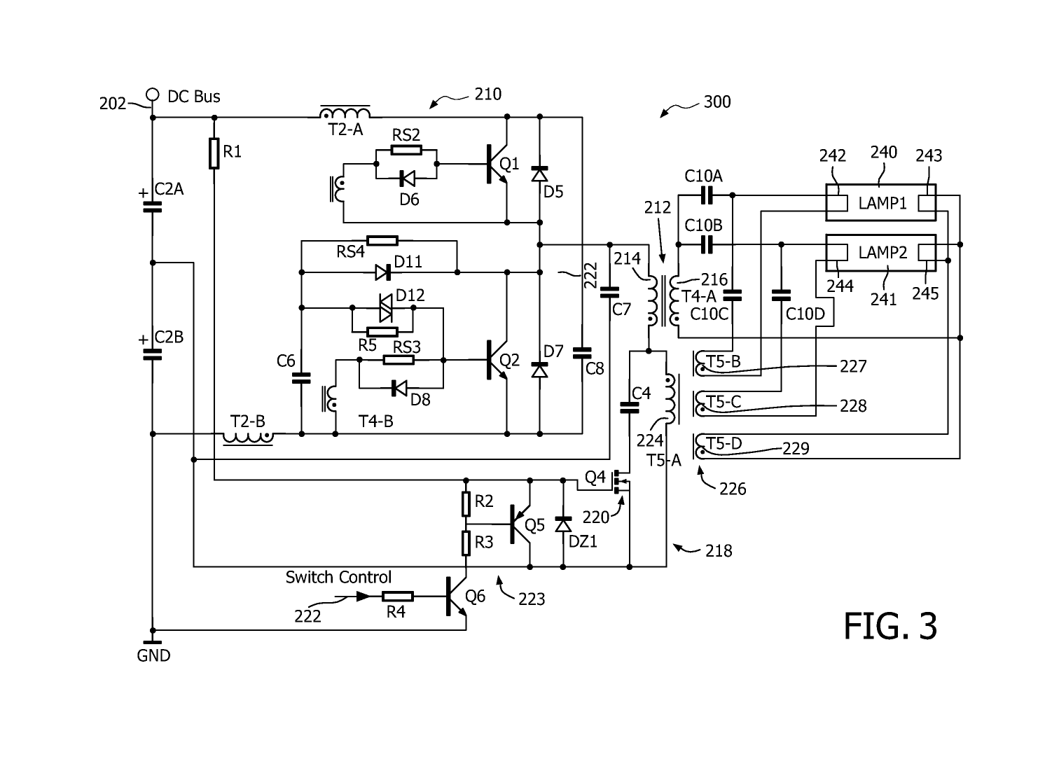

FIG. 3 is a schematic diagram of another embodiment of an electronic ballast with a switch control circuit in accordance with the present invention.

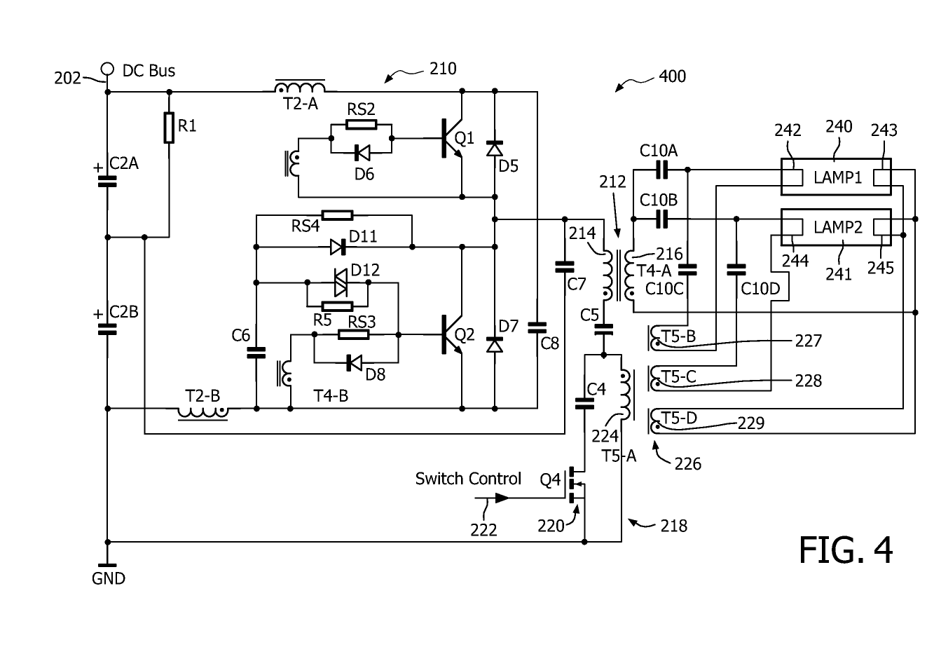

FIG. 4 is a schematic diagram of another embodiment of an electronic ballast with a MOSFET operably connected to Ground in accordance with the present invention.

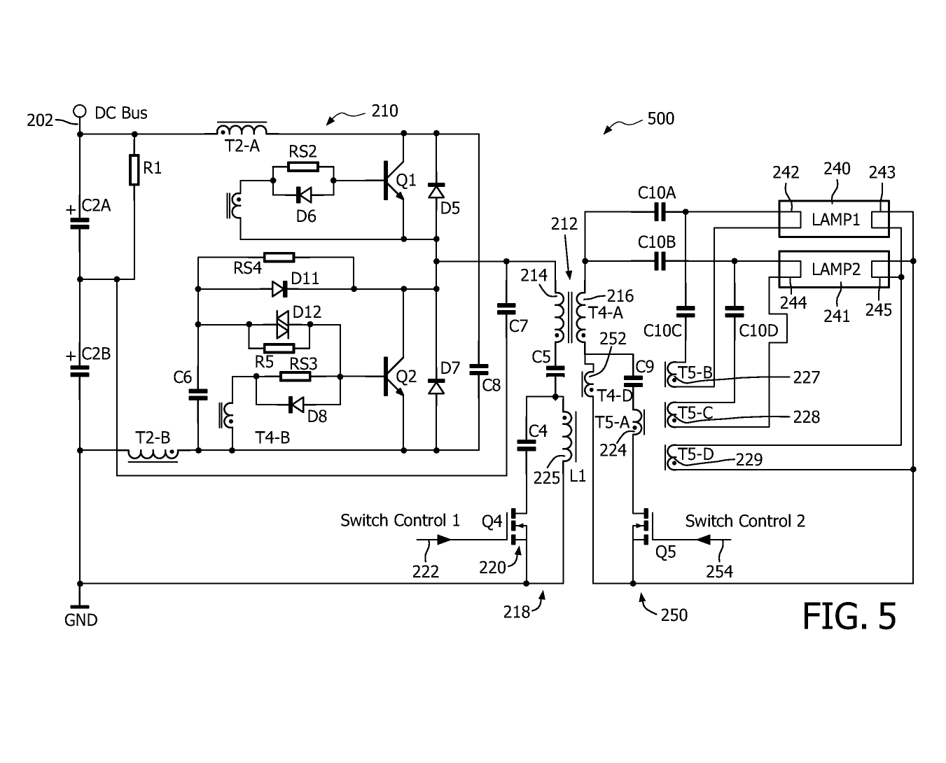

FIG. 5 is a schematic diagram of another embodiment of an electronic ballast with an independent inductor in accordance with the present invention.

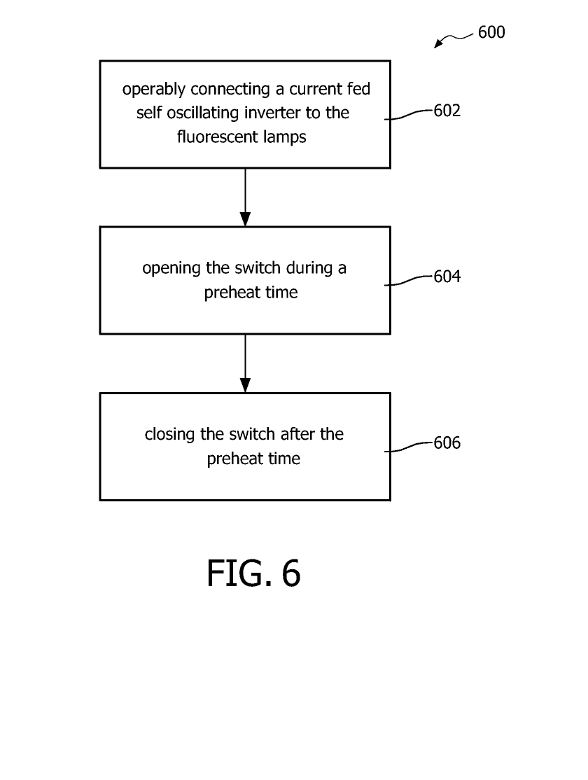

FIG. 6 is a flowchart of a method of parallel lamp operation with program start.

FIG. 1 is a block diagram of an electronic ballast in accordance with the present invention. When DC power is applied to the current fed self oscillating inverter of the electronic ballast, the current fed self oscillating inverter starts up and provides oscillating power to the lamps and the lamp filaments. Voltage is divided between a primary output transformer winding and an inductor, so that the lamps do not receive sufficient power to ignite. The inductor is shunted after a predetermined preheat time, increasing power to the lamps, which then ignite.

Electronic ballast 100 includes a current fed self oscillating inverter 110 receiving DC power 102 and providing lamp power 132 to the lamps 140 and filament power 134 to the lamp filaments 142 of the lamps 140. The lamps 140 are connected in parallel. The current fed self oscillating inverter 110 includes an output transformer 112 with a primary output transformer winding 114 and a secondary output transformer winding 116, and a switch circuit 118 having a switch 120 operably connected in parallel with an inductor 124. The switch circuit 118 is operably connected in series with the primary output transformer winding 114. The switch 120 is responsive to a preheat time signal 122 to open the switch 120 during a preheat time and close the switch after the preheat time. The primary output transformer winding 114 is operably connected to provide the lamp power 132 to the lamps 140 and the current fed self oscillating inverter 110 is operably connected to a preheat winding 127 to provide the filament power 134 to the lamp filaments 142. The current fed self oscillating inverter 110 can be any self oscillating inverter receiving DC power and providing lamp power from an output transformer. Those skilled in the art will appreciate that the DC power 102 can be provided through other components in the electronic ballast, such as an AC to DC converter. In one example, the AC to DC converter includes an electromagnetic interference (EMI) filter receiving AC mains voltage, a full wave bridge rectifier, and a power factor correction (PFC) providing the DC power 102 to the current fed self oscillating inverter 110. As used herein, the words “operably connected” are defined to mean connected, either directly or indirectly, to one another.

In operation, the current fed self oscillating inverter 110 begins operation when the DC power 102 is provided. The switch 120 is open during the preheat time, so both the primary output transformer winding 114 and the inductor 124 are included in series in the self oscillating circuit. The lamp power 132 is insufficient to ignite the lamps 140 and the filament power 134 preheats the lamp filaments 142. After the preheat time, i.e., when the lamp filaments 142 have been preheated, the preheat time signal 122 closes the switch 120 to bypass the inductor 124, shutting off the filament power 134. Only the primary output transformer winding 114 remains in the self oscillating circuit, so the lamp power 132 increases to ignite the lamps 140. Those skilled in the art will appreciate that switching the inductor 124 in and out of the circuit for the current fed self oscillating inverter 110 will change the oscillating frequency of the circuit. The preheat time signal 122 can be provided from any control circuit, such as a microcontroller, microprocessor, digital control circuit, analog control circuit, or the like.

FIG. 2 is a schematic diagram of an embodiment of an electronic ballast in accordance with the present invention. In this embodiment, the inductor is the primary filament transformer winding and the preheat windings are secondary filament transformer windings, which are operably connected to the primary filament transformer winding and operably connected to the lamp filaments.

Electronic ballast 200 includes a current fed self oscillating inverter 210 receiving DC power 202 and providing lamp power and filament power to the lamps 240, 241, which are operably connected in parallel. The current fed self oscillating inverter 210 provides lamp power through the output transformer 212 having a primary output transformer winding 214 and a secondary output transformer winding 216. The current fed self oscillating inverter 210 provides filament power to the lamp filaments through the preheat transformer 226 having primary filament transformer winding 224 operably connected to secondary filament transformer windings, which are high end preheat windings 227, 228 and a low end preheat winding 229. The high end preheat winding 227 is operably connected to the high end lamp filament 242 of the lamp 240, the high end preheat winding 228 is operably connected to the high end lamp filament 244 of the lamp 241, and the low end preheat winding 229 is operably connected in parallel to the low end lamp filaments 243, 245. Those skilled in the art will appreciate that the number of lamps connected to the electronic ballast depends on the particular application, so that the number of high end preheat windings can be selected to match the number of high end lamp filaments. For the example illustrated, there are two lamps 240, 241 with two high end lamp filaments 242, 244, so there are two high end preheat windings 227, 228. In this embodiment, the primary filament transformer winding 224 is the inductor of the switch circuit 218 and is connected in series with the primary output transformer winding 214. The switch circuit 218 includes the primary preheat winding 224 operably connected in parallel with switch 220. The switch 220 is responsive to a preheat time signal (not shown) to open the switch 220 during a preheat time and close the switch after the preheat time.

In operation, the current fed self oscillating inverter 210 begins operation when the DC power 202 is provided, with current oscillating in alternate directions through the primary output transformer winding 214 and the switch circuit 218. The switch 220 is open during this preheat time, so current passes through the primary output transformer winding 214 and the primary filament transformer winding 224. The lamp power from the output transformer 212 is insufficient to ignite the lamps 240, 241 and the filament power from the preheat transformer 226 preheats the lamp filaments 242, 243, 244, 245. After the preheat time, i.e., when the lamp filaments 242, 243, 244, 245 have been preheated, the preheat time signal closes the switch 220, which shunts the primary filament transformer winding 224 and shuts off the filament power to the lamp filaments 242, 243, 244, 245. The lamp power to the lamps 240, 241 increases because the primary filament transformer winding 224 has been effectively removed from the self oscillating circuit, so the lamps 240, 241 ignite.

FIG. 3, in which like elements share like reference numbers with FIG. 2, is a schematic diagram of another embodiment of an electronic ballast with a switch control circuit in accordance with the present invention. In this embodiment, the switch includes a capacitor in series with a MOSFET and a switch control circuit responsive to the preheat time signal controls the MOSFET.

The switch circuit 218 of the electronic ballast 300 includes the primary filament transformer winding 224 operably connected in parallel with the switch 220, which includes capacitor C4 in series with MOSFET Q4. When the MOSFET Q4 is OFF during the preheat time, the capacitor C4 charges to the maximum DC voltage of the DC power 202 through the body diode of the MOSFET Q4, so no current flows through the MOSFET Q4. The primary filament transformer winding 224 is operably connected in series with the primary output transformer winding 214.

When the MOSFET Q4 is ON during steady state operation of the current fed self oscillating inverter 210 after the preheat time, the capacitor C4 is connected in parallel with the primary filament transformer winding 224. The capacitor C4 is selected to have a high capacitance, such as 0.47 microfarads, so the capacitor C4 appears as a short at the operating frequency of the current fed self oscillating inverter 210. Thus, the primary filament transformer winding 224 is shunted by the capacitor C4 and MOSFET Q4 when the MOSFET Q4 is ON.

In this example, a switch control circuit 223 is responsive to a preheat time signal 222 to open and close the switch 220 including the capacitor C4 in series with MOSFET Q4. The switch control circuit 223 is operably connected between the gate and the source of the

MOSFET Q4 and allows the source of MOSFET Q4 to be connected between capacitor C2A and capacitor C2B, which are connected between the DC Bus and Ground. The switch control circuit 223 includes resistor R1, zener diode DZ1, pnp transistor Q5, resistor R2, resistor R3, and npn transistor Q6. The resistor R1 is connected between the DC Bus and the gate of MOSFET Q4. The zener diode DZ1 is connected in parallel between the gate and source of MOSFET Q4. The pnp transistor Q5 is also connected in parallel across the MOSFET Q4, with the emitter of the pnp transistor Q5 connected to the gate of MOSFET Q4 and the collector of the pnp transistor Q5 connected to the source of MOSFET Q4. A series circuit including resistor R2, resistor R3, and npn transistor Q6 is connected between the gate of MOSFET Q4 and Ground. The base of the pnp transistor Q5 is connected between the resistor R2 and resistor R3, which act as a voltage divider. The base of the npn transistor Q6 is connected to receive the preheat time signal 222 through resistor R4.

The preheat time signal 222 is set high at a positive voltage for the preheat time. The high voltage on the base of the npn transistor Q6 turns on npn transistor Q6 to allow current flow through the resistor R2, resistor R3, and npn transistor Q6. The voltage drop across resistor R2 turns on pnp transistor Q5 to set the gate of the MOSFET Q4 low to keep the MOSFET Q4 off. The switch 220 including the MOSFET Q4 is open, so the primary filament transformer winding 224 is connected in series with the primary output transformer winding 214.

The preheat time signal 222 is set low at zero voltage for steady state operation after the preheat time. The zero voltage on the base of the npn transistor Q6 keeps the npn transistor Q6 off, so no current flows through the resistor R2, resistor R3, and npn transistor Q6. There is no voltage drop across resistor R2, so pnp transistor Q5 is off and the gate of the MOSFET Q4 is high to turn on the MOSFET Q4. The zener diode DZ1 limits the voltage on the gate of MOSFET Q4 to a safe value during switching. The switch 220 including the MOSFET Q4 is closed, so the primary filament transformer winding 224 is shunted.

FIG. 4, in which like elements share like reference numbers with FIG. 3, is a schematic diagram of another embodiment of an electronic ballast with a MOSFET operably connected to Ground in accordance with the present invention. In this embodiment, a capacitor is operably connected in series between the primary output transformer winding and the switch circuit, the source of the MOSFET is operably connected to Ground, and the gate of the MOSFET is responsive to the preheat time signal to turn the MOSFET ON and OFF.

The switch circuit 218 of the electronic ballast 400 includes the primary filament transformer winding 224 operably connected in parallel with the switch 220, which includes capacitor C4 in series with MOSFET Q4. The switch circuit 218 is operably connected in series with the primary output transformer winding 214 and capacitor C5. The source of the MOSFET Q4 and the terminal of the primary filament transformer winding 224 away from the capacitor C5 are operably connected to Ground. Connecting the MOSFET Q4 to Ground changes the average voltage at the MOSFET Q4 compared to the average voltage at the primary output transformer winding 214, so the capacitor C5 is added between the primary output transformer winding 214 and the switch circuit 218 to block DC current due to the DC shift. The capacitor C5 is selected to have a high capacitance, such as 0.22 microfarads, so the capacitor C5 appears as a short at the operating frequency of the current fed self oscillating inverter 210.

Any control circuit can be used to control the MOSFET Q4 directly. The preheat time signal 222 is set low to turn off the MOSFET Q4 for the preheat time when starting up the electronic ballast 200. The primary filament transformer winding 224 is operably connected in series with the primary output transformer winding 214. The preheat time signal 222 is set high at a positive voltage to turn on the MOSFET Q4 for steady state operation after the preheat time. Thus, the primary filament transformer winding 224 is shunted by the capacitor C4 and MOSFET Q4 when the MOSFET Q4 is ON.

FIG. 5, in which like elements share like reference numbers with FIG. 4, is a schematic diagram of another embodiment of an electronic ballast with an independent inductor in accordance with the present invention. In this embodiment, the inductor is an independent inductor and a filament control circuit controls current through the lamp filaments.

The switch circuit 218 of the electronic ballast 500 includes an independent inductor 225 operably connected in parallel with the switch 220, which includes capacitor C4 in series with MOSFET Q4. The output transformer 212 includes the primary output transformer winding 214 and a secondary output transformer filament winding 252 operably connected in series with the secondary output transformer winding 216. The filament control circuit 250, which includes capacitor C9, primary filament transformer winding 224, and MOSFET Q5 operably connected in series, is operably connected in parallel with the secondary output transformer filament winding 252. The primary filament transformer winding 224 is operably connected to secondary filament transformer windings, which are high end preheat windings 227, 228 and a low end preheat winding 229. The MOSFET Q5 is responsive to a filament control signal 254 to turn the MOSFET Q5 ON and OFF. The capacitor C9 is a DC blocking capacitor.

In operation during the preheat time, the preheat time signal 222 is low to turn OFF the MOSFET Q4, so the switch 220 is open and current passes through the primary output transformer winding 214 and the independent inductor 225. The voltage across the primary output transformer winding 214 is reduced by the presence of the independent inductor 225 in the current path. The filament control signal 254 is high to turn ON the MOSFET Q5, so part of secondary voltage of the output transformer 212 is applied to the primary filament transformer winding 224 through the capacitor C9. The primary filament transformer winding 224 provides heating current to the lamp filaments 242, 243, 244, 245 through the high end preheat windings 227, 228 and low end preheat winding 229.

Connecting the secondary output transformer winding 216 in series with the primary filament transformer winding 224 avoids high glow current and prevents the lamps from ignited during the preheat time. The cold resistance of the lamp filaments is typically much lower than the hot resistance, so there is higher current through the primary filament transformer winding 224 at the beginning of the preheat time. The current through the primary filament transformer winding 224 is reflected in the primary output transformer winding 214 and causes higher primary output transformer winding current. This increased primary current causes an increase of voltage across the independent inductor 225, decreases the voltage across the primary output transformer winding 214, and lowers lamp voltage from the secondary output transformer winding 216 to avoid high glow current and prevent the lamps from igniting.

In operation after the preheat time, the preheat time signal 222 is set high to turn ON the MOSFET Q4, so the switch 220 is closed and the independent inductor 225 is shunted. This increases the voltage across the primary output transformer winding 214 to ignite the lamps 240, 241. The filament control signal 254 is set low to turn OFF the MOSFET Q5. The capacitor C9 charges to high voltage, so there is no current through the primary filament transformer winding 224 and the filament heating is turned off. Those skilled in the art will appreciate that the value of the capacitor C9 can be selected to provide a low impedance at the preheat frequency, such as a value of 47 nanofarads or 220 nanofarads.

In some applications, such as low ballast factor applications, filament heating is desired during steady state operation after the preheat time. In one embodiment, an additional capacitor can be connected in parallel with the MOSFET Q5 between the drain and source of the MOSFET Q5. Current will flow through the capacitor and the primary filament transformer winding 224 even when the MOSFET Q5 is OFF, heating the lamp filaments. Those skilled in the art will appreciate that the value of the capacitor can be selected to provide the desired amount of filament heating required for a particular application.

FIG. 6 is a flowchart of a method of parallel lamp operation with program start. The method 600 of lamp operation with program start for fluorescent lamps operably connected in parallel includes operably connecting a current fed self oscillating inverter to the fluorescent lamps 602, opening the switch during a preheat time 604; and closing the switch after the preheat time 606. The current fed self oscillating inverter includes an output transformer having a primary output transformer winding and a secondary output transformer winding, the secondary output transformer winding being operably connected to provide lamp power to the fluorescent lamps; and a switch circuit operably connected in series with the primary output transformer winding, the switch circuit having a switch operably connected in parallel with an inductor. In one embodiment, each of the fluorescent lamps has lamp filaments and the method 600 further includes providing filament power to the lamp filaments during the preheat time. The method 600 can also include turning off the filament power to the lamp filaments after the preheat time or reducing the filament power to the lamp filaments after the preheat time. In another embodiment, the method 600 can also include receiving AC mains voltage at an AC to DC converter, and providing DC power from the AC to DC converter to the current fed self oscillating inverter.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. An electronic ballast for fluorescent lamps operably connected in parallel, each of the fluorescent lamps having lamp filaments, the electronic ballast comprising:
a current fed self oscillating inverter (110) comprising:
an output transformer (112) having a primary output transformer winding (114) and a secondary output transformer winding (116), the secondary output transformer winding (116) being operably connected to provide lamp power (132) to the fluorescent lamps; and
a switch circuit (118) operably connected in series with the primary output transformer winding (114), the switch circuit (118) having a switch (120) operably connected in parallel with an inductor (124), the switch (120) being responsive to a preheat time signal (122) to open the switch (120) during a preheat time and close the switch (120) after the preheat time;
preheat windings (127) operably connected to the current fed self oscillating inverter (110) to provide filament power (134) to the lamp filaments during the preheat time.

2. The electronic ballast of claim 1 wherein:
the lamp filaments comprise high end lamp filaments and low end lamp filaments, each of the fluorescent lamps having one of the high end lamp filaments and one of the low end lamp filaments; and
the secondary filament transformer windings comprise high end preheat windings and a low end preheat winding, each of the high end preheat windings being operably connected to one of the high end lamp filaments, and the low end preheat winding being operably connected in parallel across the low end lamp filaments.

3. The electronic ballast of claim 1 further comprising an AC to DC converter operably connected to receive AC mains voltage and provide DC power to the current fed self oscillating inverter.

4. The electronic ballast of claim 1 wherein:
the inductor is a primary filament transformer winding; and
the preheat windings are secondary filament transformer windings operably connected to the primary filament transformer winding.

5. The electronic ballast of claim 4 wherein the switch comprises a capacitor in series with a MOSFET.

6. The electronic ballast of claim 5 wherein the MOSFET has a gate and a source, the electronic ballast further comprising a switch control circuit operably connected between the gate and the source, the switch control circuit being responsive to the preheat time signal to turn the MOSFET ON and OFF.

7. The electronic ballast of claim 5 wherein the MOSFET has a gate and source, the electronic ballast further comprising a capacitor operably connected in series between the primary output transformer winding and the switch circuit, wherein the source is operably connected to Ground and the gate is responsive to the preheat time signal to turn the MOSFET ON and OFF.

8. The electronic ballast of claim 1 wherein the output transformer further comprises a secondary output transformer filament winding connected in series with the secondary output transformer winding, the electronic ballast further comprising:
a filament control circuit operably connected in parallel with the secondary output transformer filament winding, the filament control circuit comprising a capacitor, a primary filament transformer winding, and a MOSFET operably connected in series;
wherein:
the primary filament transformer winding is operably connected to the preheat windings; and
the MOSFET is responsive to a filament control signal to turn ON the MOSFET during the preheat time and to turn OFF the MOSFET after the preheat time.

9. The electronic ballast of claim 8 wherein the capacitor is a first capacitor, the electronic ballast further comprising a second capacitor operably connected in parallel with the MOSFET between a drain of the MOSFET and a source of the MOSFET.

10. The electronic ballast of claim 8 wherein the capacitor is a first capacitor, the MOSFET is a first MOSFET, and the switch comprises a second capacitor in series with a second MOSFET.

11. The electronic ballast of claim 10 wherein the second MOSFET has a gate and a source, the electronic ballast further comprising a third capacitor operably connected between the primary output transformer winding and the switch circuit, wherein the source is operably connected to Ground and the gate is responsive to the preheat time signal to turn the second MOSFET ON and OFF.

12. A method of lamp operation with program start for fluorescent lamps operably connected in parallel, the method comprising:
operably connecting a current fed self oscillating inverter to the fluorescent lamps (602), the current fed self oscillating inverter comprising:
an output transformer having a primary output transformer winding and a secondary output transformer winding, the secondary output transformer winding being operably connected to provide lamp power to the fluorescent lamps; and
a switch circuit operably connected in series with the primary output transformer winding, the switch circuit having a switch operably connected in parallel with an inductor;
opening the switch during a preheat time (604); and
closing the switch after the preheat time (606).

13. The method of claim 12 wherein each of the fluorescent lamps has lamp filaments, the method further comprising:
providing filament power to the lamp filaments during the preheat time.

14. The method of claim 13 further comprising:
turning off the filament power to the lamp filaments after the preheat time.

15. The method of claim 13 further comprising:
reducing the filament power to the lamp filaments after the preheat time.

16. The method of claim 12 further comprising:
receiving AC mains voltage at an AC to DC converter; and
providing DC power from the AC to DC converter to the current fed self oscillating inverter.

17. An electronic ballast for fluorescent lamps operably connected in parallel, each of the fluorescent lamps having a high end lamp filament and a low end lamp filament, the electronic ballast comprising:
a current fed self oscillating inverter (210) comprising:
an output transformer (212) having a primary output transformer winding (214) and a secondary output transformer winding (216) operably connected in series with a secondary output transformer filament winding (252), the secondary output transformer winding (216) being operably connected to provide lamp power to the fluorescent lamps;
a switch circuit (218) operably connected in series with the primary output transformer winding (214), the switch circuit (218) having a switch (220) operably connected in parallel with an independent inductor (225), the switch (220) including a first capacitor and first MOSFET in series, a source of the first MOSFET being operably connected to Ground, the switch (220) being responsive to a preheat time signal (222) to open the switch (220) during a preheat time and close the switch (220) after the preheat time; and
a second capacitor operably connected between the primary output transformer winding (214) and the switch circuit (218);
a filament control circuit (250) operably connected in parallel with the secondary output transformer filament winding (252), the filament control circuit (250) comprising:
a third capacitor, a primary filament transformer winding (224), and a second MOSFET operably connected in series, the second MOSFET being responsive to a filament control signal to turn ON the second MOSFET during the preheat time and to turn OFF the second MOSFET after the preheat time;
high end preheat windings operably connected to the primary filament transformer winding (224), each of the high end preheat windings being operably connected to one of the high end lamp filaments; and
a low end preheat winding operably connected to the primary filament transformer winding (224), the low end preheat winding being operably connected in parallel across the low end lamp filaments.

18. The electronic ballast of claim 17 further comprising a fourth capacitor operably connected in parallel with the second MOSFET between a drain of the second MOSFET and a source of the second MOSFET.

19. The electronic ballast of claim 17 further comprising an AC to DC converter operably connected to receive AC mains voltage and provide DC power to the current fed self oscillating inverter.
